(19) United States
(12) Patent Application Publication
(10) Pub. No.: US 2010/0075547 A1
(43) Pub. Date: Mar. 25, 2010

(54) HOLDING DEVICE FOR PROBE CONNECTOR

(76) Inventors: Jui-Pin LIN, Tu-Cheng City (TW); Te-Hung YIN, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/234,870

(22) Filed: Sep. 22, 2008

(51) Int. Cl. H01R 13/11

(52) U.S. Cl. 439/857

(57) ABSTRACT

A holding device adapted for holding a probe connector includes a holding portion. The holding portion includes a substantially cylinder-shaped sidewall. A recess is surrounded by the sidewall and extends along an axial direction of the holding portion. At least one pair of outlets adjacent to each other is defined in the sidewall and extends along the axial direction of the holding portion to pass through an end of the sidewall. A cantilever arm is formed between the pair of outlets. A hook is defined in substantially a free end of an inner surface of the cantilever arm. The holding device defines at least one pair of outlets in the holding portion, the air in the recess of the holding portion can be exhausted through the outlets when the holding device holding the probe connector, which prevents the probe connector being pushed out from the holding portion by the inflated air in the recess.

### BACKGROUND OF THE INVENTION

1. Field of the Invention

The present invention relates to a holding device for a probe connector, and particularly to a holding device for holding the probe connector to solder on a printed circuit board.

2. The Related Art

A conventional probe connector is usually soldered to a printed circuit board by means of SMT and needs an automatic holding device for holding the probe connector to solder to the printed circuit board. A conventional holding device utilizes a nozzle to remove the probe connector to the printed circuit board. However, as a plunger of the probe connector is of a cylindrical shape, the probe connector is easy to escape from the nozzle when the probe connector is removed to the printed circuit board by the nozzle.

To solve the problem described above, a holding device for holding the probe connector is provided. With reference to FIGS. 1 and 2, a conventional holding device 1′ for a probe connector 2′ is shown. The probe connector 2′ includes a cylindrical barrel 20′ with a space (not shown) therein, and a plunger 21′ one end of which is movably received in the space of the barrel 20′ and the other end of which extends out of the barrel 20′. The holding device 1′ is made from a plastic material. The holding device 1′ includes a cylindrical tube 11′. A recess 110′ is defined in the tube 11′ and extends along an axial direction of the tube 11′ to penetrate a bottom surface of the tube 11′. When the probe connector 2′ is held to a welding furnace (not shown) by the holding device 1′ for being soldered to the printed circuit board, as the temperature in the welding furnace is high, the holding device 1′ made from a plastic material is easy to be deformed. And air sealed in the recess 110′ is inflated when the holding device 1′ is heated, which makes the probe connector 2′ easy to be pushed out from the holding device 1′ by the inflated air in the recess 110′.

### SUMMARY OF THE INVENTION

Accordingly, an object of the present invention is to provide a holding device. The holding device adapted for holding a probe connector includes a holding portion. The holding portion includes a substantially cylinder-shaped sidewall. A recess is surrounded by the sidewall and extends along an axial direction of the holding portion. At least one pair of outlets adjacent to each other is defined in the sidewall and extends along the axial direction of the holding portion to pass through an end of the sidewall. A cantilever arm is formed between the pair of outlets. A hook is defined in substantially a free end of an inner surface of the cantilever arm.

As described above, the holding device defines at least one pair of outlets in the holding portion, the air in the recess of the holding portion can be exhausted through the outlets when the holding device holding the probe connector, which prevents the probe connector being pushed out from the holding portion by the inflated air in the recess. The cantilever arm with a hook thereon can prevent the probe connector falling from the holding device.

### BRIEF DESCRIPTION OF THE DRAWINGS

The present invention will be apparent to those skilled in the art by reading the following description of a preferred embodiment thereof, with reference to the accompanying drawings, in which:

FIG. 1 is a perspective view of a conventional holding device and a probe connector before the holding device holds the probe connector;

FIG. 2 is a cross-section view of the conventional holding device in FIG. 1 holding the probe connector;

FIG. 3 is a perspective view of a holding device according to the present invention and a probe connector before the holding device holds the probe connector;

FIG. 4 is a cross-section view of the holding device in FIG. 3 holding the probe connector; and

FIG. 5 is another cross-section view of the holding device in FIG. 3 holding the probe connector.

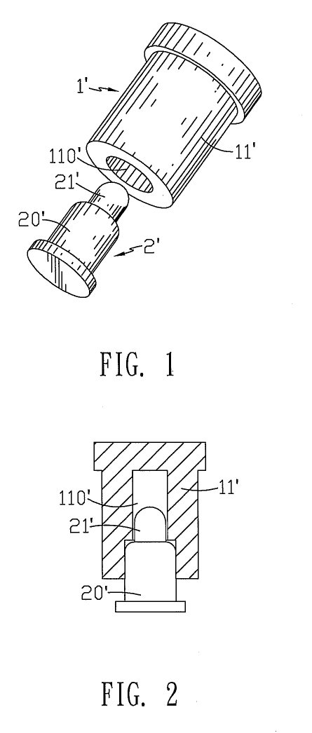

### DETAILED DESCRIPTION OF THE PREFERRED EMBODIMENT

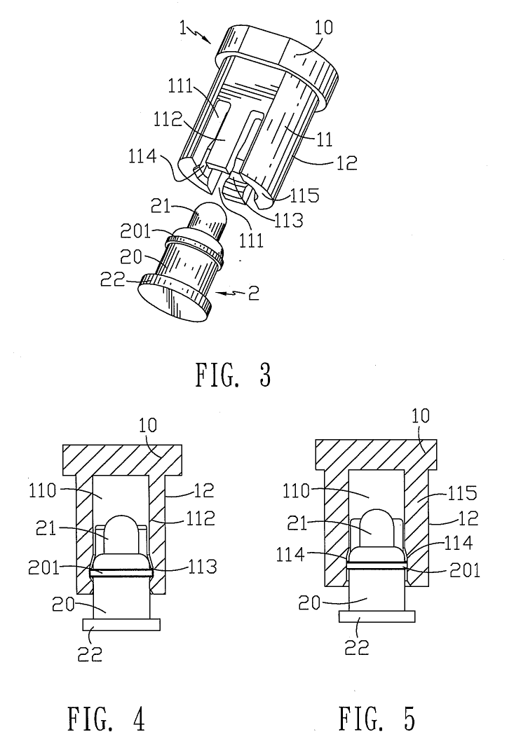

With reference to FIGS. 3, 4 and 5, a probe connector 2 includes a discoidal base 22. An upper surface of the base 22 extends upward to form a hollow tube 20 of a cylindrical shape. The diameter of the tube 20 is slightly smaller than that of the base 22. An upper portion of an outer surface of the tube 20 protrudes outward to form a circular flange 201. A plunger 21 one end of which is movably received in the tube 20 and the other end of which extends out of the tube 20.

A holding device 1 according to the present invention is made from a plastic material. The holding device 1 has a substantially cylindrical connecting portion 10. A bottom surface of the connecting portion 10 extends downward to form a holding portion 11. The diameter of the holding portion 11 is slightly less than that of the connecting portion 10. The holding portion 11 has a substantially cylinder-shaped sidewall 12. A recess 110 is formed in one end of the holding portion 11 opposite to the connecting portion 10 and extends along an axial direction of the holding portion 11. Two pairs of outlets 111 are symmetrically formed in the sidewall 12 with substantially equivalent space between each other and extend along the axial direction of the holding portion 11 to pass through a bottom end of the sidewall 12. The outlets 111 communicate with the recess 110. The part of the sidewall 12 between each pair of outlets 111 is defined as a cantilever arm 112. A hook 113 is formed in substantially a free end of an inner surface of the cantilever arm 112. The parts of the sidewall 12 between the adjacent pair of outlets 111 are defined as a pair of holding arms 115. A bottom portion of an inner surface of each holding arm 115 defines a depression 114 therein. The holding arms 115 are much wider than the cantilever arms 112 for restricting the probe connector 2 from swaying.

When the probe connector 2 is held to solder to a printed circuit board (not shown), the tube 20 of the probe connector 2 is inserted into the recess 110 of the holding portion 11. A part of the flange 201 is held by the hooks 113 of the cantilever arms 112, which prevents the probe connector 2 from falling out of the holding device 1. The other part of the flange 201 is received in the depressions 114 of the holding arms 115, which prevents the probe connector 2 from swaying in the holding device 1.

The holding portion 11 can defines at least one pair of outlets therein. The plural pairs of outlets 111 are disposed equidistantly in the holding portion 11.

As described above, the holding device 1 for the probe connector 2 defines plural pairs of outlets 111 in the holding portion 11 equidistantly. When the probe connector 2 is removed to the welding furnace by the holding device 1, the air in the recess 110 of the holding portion 11 is heated and exhausted through the outlets 111, which prevents the probe connector 2 from being pushed out of the holding portion 11 by the inflated air in the recess 110. The cantilever arms 112 and the holding arms 115 respectively disposed equidistantly in the sidewall 12 provide the probe connector 2 balanceable forces to prevent the probe connector 2 from leaning in the holding device 1. The cantilever arms 112 with hooks 113 holding the probe connector 2 can prevent the probe connector 2 from falling out of the holding device 1. The holding arms 115 with depressions 114 holding the probe connector 2 can prevent the probe connector 2 from swaying in the holding device 1. Thereby the holding device 1 according to the present invention holds the probe connector 2 steadily.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A holding device adapted for holding a probe connector, comprising:
a holding portion including a substantially cylinder-shaped sidewall, a recess enclosed by the sidewall and extending along an axial direction of the holding portion, at least one pair of outlets adjacent to each other defined in the sidewall and extending along the axial direction of the holding portion to pass through an end of the sidewall, a cantilever arm formed between the pair of outlets, a hook defined in substantially a free end of an inner surface of the cantilever arm.

2. The holding device as claimed in claim 1, wherein a plurality of pairs of outlets are defined in the sidewall with substantially equivalent space between each other to define a plurality of cantilever arms, part of the sidewall between the adjacent pairs of outlets is much wider than the corresponding cantilever arm for restricting the probe connector from swaying.

3. The holding device as claimed in claim 1, further comprising a connecting portion enclosing an end of the holding portion away from the outlets.
